(19) United States
(12) Patent Application Publication
(10) Pub. No.: US 2016/0179767 A1
(43) Pub. Date: Jun. 23, 2016

(54) ARCHITECTURE FOR AN APPLICATION WITH INTEGRATED DYNAMIC CONTENT

(71) Applicants: Prasanna Bhat Mavinakuli, Sagar (IN); Ashish Kumar Sinha, Bangalore (IN); Balasubramaniyan Krithivasan, Bangalore (IN)

(72) Inventors: Prasanna Bhat Mavinakuli, Sagar (IN); Ashish Kumar Sinha, Bangalore (IN); Balasubramaniyan Krithivasan, Bangalore (IN)

(21) Appl. No.: 14/579,624

(22) Filed: Dec. 22, 2014

(51) Int. Cl. G06F 17/22; G06F 3/0481; H04L 12/927; G06F 17/27

(52) U.S. Cl. CPC G06F 17/2247; G06F 17/2705; G06F 3/0481; H04L 47/803

(57) ABSTRACT

Innovations for architectures for an application with integrated dynamic content are presented. Example architectures provide a generic way to integrate dynamic content into an application. For example, a container in an application architecture requests a Web page for an application and also requests at least some resources for the application from a backend server embedded in the application. The container receives the requested Web page. It also receives the requested at least some resources from the backend server. The container renders the Web page, which includes elements of a user interface of the application. At least some of the elements of the user interface are actuatable to launch services. The container handles user input to the application and, in response to certain user input, launches one of the services.

### BACKGROUND

In the area of computer software, an application is a computer program that helps a user perform one or more activities such as retrieval of data, manipulation of data, presentation of data, or communication with another user. When it runs on a computer system, an application uses services provided by an operating system of the computer system. A user interface (“UI”) allows a user to interact with the computer system (e.g., the application, the operating system) through text command or controls, icons and other elements, which the user can manipulate to cause the computer system to perform operations. Conventionally, an application is provided as a collection of executable files, libraries and related resources, which may be delivered by physical media (such as a compact disk or flash drive) or via a network connection, and installed on a computer system.

A conventional application has a static UI defined in the collection of executable files, libraries, related resources, etc. for the application. In part, the UI of a conventional application rarely changes due to the cumbersome process of updating the executable files, libraries, related resources, etc. for the application. Another factor is the slow feedback loop between users and the designer of the conventional application (e.g., a user suggesting changes, the designer considering the suggested changes as well as effects for other users, the designer eventually changing the UI, and the user updating the application). These factors limit options for providing new content or information to the user through the UI of the application, and they impede the process of changing the UI to adapt to the preferences of the user.

### SUMMARY

In summary, the detailed description is directed to various innovations for architectures for an application with integrated dynamic content such as a live feed, marketing feed and/or dynamic Web page. Example architectures provide a generic way to integrate dynamic content into an application. Example architectures provide various other advantages as described herein.

According to one aspect of the innovations described herein, an application architecture includes a container and a backend server. The container is configured to request a Web page for an application and request resources for the application. For example, the container is configured to request, at start up, a current version of the Web page from a remote server. Or, as another example, the container is configured to request, at start up, an initial version of the Web page from the backend server. At least some of the resources for the application (e.g., text for elements of the UI of the application, images, settings) can be requested from the backend server.

The container is also configured to render the Web page for the application. For example, the container is configured to parse markup language code for the Web page. The markup language code can include hypertext markup language (“HTML”) code, extensible markup language (“XML”) code, or some other type of markup language code. Or, as another example, the container is configured to create a document object model (“DOM”). The DOM can be used to represent objects in the Web page and expose ways for a user to manipulate the objects in the Web page. Or, as another example, the container is configured to interpret script code for the Web page. The script code can specify ways for the container to manage interactions between the user and the Web page (e.g., by calls to methods of objects of a DOM for the Web page). Or, as another example, the container is configured to perform some combination of parsing markup language code for the Web page, creating a DOM, and interpreting script code for the Web page.

The container can control access to operations of the application in various ways. For example, in some implementations, the container is configured to declare a script function in a DOM (for the Web page for the application), initialize an operation of the application, and, in response to invocation of the operation of the application within the container, call the script function to perform the operation. (In contrast, invocation of the operation by a Web browser fails to call the script function to perform the operation.) The container can also be configured to selectively launch a service or Web browser when processing an external Web link. The container checks whether the external Web link corresponds to a script function defined in a DOM (for the Web page for the application). If so, the container invokes the script function to launch a service to de-reference the external Web link. Otherwise, the container launches a new browser window to de-reference the external Web link. Or, as another example, in some implementations, the container can be configured to check authentication when invoking a script function defined in a DOM (for the Web page for the application). The container generates an authentication token when initializing the application, and passes the authentication token to a client (e.g., one of the services or a desktop client). When the container receives a request to invoke the script function, the container checks that the request is accompanied by the authentication token as a condition of invoking the script function.

The container can adjust how the application is presented on a computer system depending on the form factor of the computer system or window size for the application. For example, the container is configured to request style sheet information for the application, evaluate configuration information for a display device or window and, when rendering the Web page for the application, set layout of the application based on one or more fields (e.g., media tags) of the style sheet information and based on the configuration information for the display device or window.

The rendered Web page includes graphical elements of a UI of the application. At least some of the graphical elements are actuatable to launch services (e.g., a service to acquire data, a chat service, a help service, and/or some other service). The container is configured to handle user input to the application, and to launch one of the services (e.g., in response to user input). The container can further be configured to receive a user input event, and pass the user input event to one of the services or components the application.

The backend server, which is embedded in the application, is configured to retrieve at least some of the requested resources for the application. To localize the application, the container and backend server can adapt the application to different languages or locales. For example, the backend server is configured to receive an indication of language or locale and, based on the indication of language or locale, retrieve strings of text elements of the UI of the application. In this case, the backend server is also configured to return the strings to the container, for use in the rendered Web page.

The container can handle various types of errors. For example, the container is configured to detect an error condition for the application, such as a network error condition, service error condition, or application error condition. To handle the error condition, the container is configured to request a standby version of the Web page from the backend server. Or, as another example, the container is configured to detect an error condition for a given service of the services. To handle such an error condition, the container is configured to request an offline version of the given service from the backend server. The offline version of the given service is, for example, a static Web page.

To reduce network traffic and/or improve response time, the application architecture can include a cache configured to store Web pages and related resources for the application. In this case, the container can be configured to check, before requesting a given Web page or related resource, whether the cache includes the given Web page or related resource and/or check whether the given Web page or related resource has changed since being stored in the cache.

According to another aspect of the innovations described herein, a container in an application architecture requests a Web page for an application and also requests at least some resources for the application from a backend server embedded in the application. The container receives the requested Web page. It also receives the requested at least some resources from the backend server. The container renders the Web page, which includes elements of a UI of the application. At least some of the elements of the UI are actuatable to launch services. The container handles user input to the application and, in response to certain user input, launches one of the services. When configured appropriately, the container and/or backend server can perform various other operations as described in the preceding paragraphs.

The innovations can be implemented as part of a method, as part of a computing system adapted to perform the method or as part of non-transitory computer-readable media storing computer-executable instructions for causing a computing system to perform the method. The various innovations can be used in combination or separately. The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram of an example computing system in which some described embodiments can be implemented.

FIG. 2 is a diagram of an example cloud computing environment in which some described embodiments can be implemented.

FIG. 3 is a block diagram of an example software architecture for an application with integrated dynamic content.

FIG. 4 is a flowchart of a generalized technique for presenting an application with integrated dynamic content.

FIGS. 5a-5c are a pseudocode listing of examples of functions and other statements used when integrating dynamic content into a desktop application.

FIGS. 6a-6d are a pseudocode listing of example style sheet information that can be used to adapt presentation of a desktop application with integrated dynamic content.

FIGS. 7a and 7b are a pseudocode listing of examples of data objects used to localize the UI of a desktop application with integrated dynamic content.

FIGS. 8a, 8b, and 9 are pseudocode listings of examples of functions and other statements used when handling error conditions in a desktop application with integrated dynamic content.

FIGS. 10a-10c are pseudocode listings of examples of functions and other statements used when controlling access to script functions of a DOM for a desktop application with integrated dynamic content.

FIG. 11 is a pseudocode listing of examples of functions and other statements used for authentication in a desktop application with integrated dynamic content.

FIG. 12 is a pseudocode listing of statements used to define a control for launching a live chat service in a desktop application with integrated dynamic content.

FIGS. 13a and 13b are pseudocode listings of examples of functions and other statements used when processing an external Web link in a desktop application with integrated dynamic content.

FIG. 14 is a pseudocode listing of example files in a cache for a desktop application with integrated dynamic content.

### DETAILED DESCRIPTION

The detailed description presents various features of architectures for an application with integrated dynamic content. Depending on implementation, example architectures described herein can provide one or more of the following advantages.
In some cases, architectures facilitate integration of a dynamic Web page, live feed, marketing feed and/or other dynamic content into an application. Such architectures provide a generic way to integrate dynamic content. Using one of these mechanisms, a service or marketing team can provide information to users so that the users have up-to-date information about the application or information about other applications.
In some cases, architectures provide convenient ways to change an application based on user feedback. For example, in such architectures, the user interface (“UI”) of the application can be specified at least in part using a dynamic Web page. If a user requests a change for a welcome screen specified with the Web page (or for another screen of the application specified with the Web page, or for the overall user experience or functionality of the application specified with the Web page), the change can be made without waiting for the next release of the application. Instead, the change to the UI can be applied to the dynamic Web page for the application, which is hosted in a server, and made available to the user, which helps to make the application more appealing to the user.
Similarly, in some cases, architectures provide a convenient way to notify users about updates and new versions of an application, with details of new enhancements, etc., and to push those updates and new versions of the application to users. Thus, the users have the latest version of the application.
In some cases, architectures provide ways to integrate live chat, online help, tutorial videos and other services. For example, a user can have live chat with a support person when the user is using the application, even starting the live chat service from a home screen of the application. As another example, the user can start tutorial videos or access other help materials in a Web browser launched from the home screen of the application.
In some cases, architectures provide ways for an application provider to learn how an application is actually being used in real-world scenarios. For example, the application provider can monitor a live feed or dynamic Web page for the application. The application provider can then tailor the UI of the application to the needs, preferences, expectations, or work patterns of a user or group of users, making the UI of the application more intuitive to the users.

In many of the examples described herein, a desktop application integrates dynamic content. The desktop application provides a user experience similar to a standalone application, which runs by itself in a computer system as opposed to running in an environment supported by a Web browser. In implementation, the desktop application uses a client-server architecture in which one or more client-side components (including a container) communicate with one or more remote server-side components. Even when implemented using the client-server architecture, the desktop application has comparable performance to a standalone application running by itself on a computer system, without integrated dynamic content.

In many of the examples described herein, a desktop application integrates a dynamic Web page to provide functionality for the UI of the desktop application. The dynamic Web page provides an interactive user experience in which the UI changes in response to different contexts or conditions. A client-side component (namely, the container) can parse the dynamic Web page, create a document object model (“DOM”) for the dynamic Web page, and execute script code to manage interactions between the user and DOM for the dynamic Web page. The content of the dynamic Web page may change over time in response to user input or in response to updates from a server (e.g., for a live feed or marketing feed).

In the examples described herein, identical reference numbers in different figures indicate an identical component or module. Depending on context, a given component or module may accept a different type of information as input and/or produce a different type of information as output. More generally, various alternatives to the examples described herein are possible. For example, some of the methods described herein can be altered by changing the ordering of the method acts described, by splitting, repeating, or omitting certain method acts. The various aspects of the disclosed technology can be used in combination or separately. Different embodiments use one or more of the described innovations. Some of the innovations described herein address one or more of the problems noted in the background. Typically, a given technique/tool does not solve all such problems.

### I. Example Computing Systems.

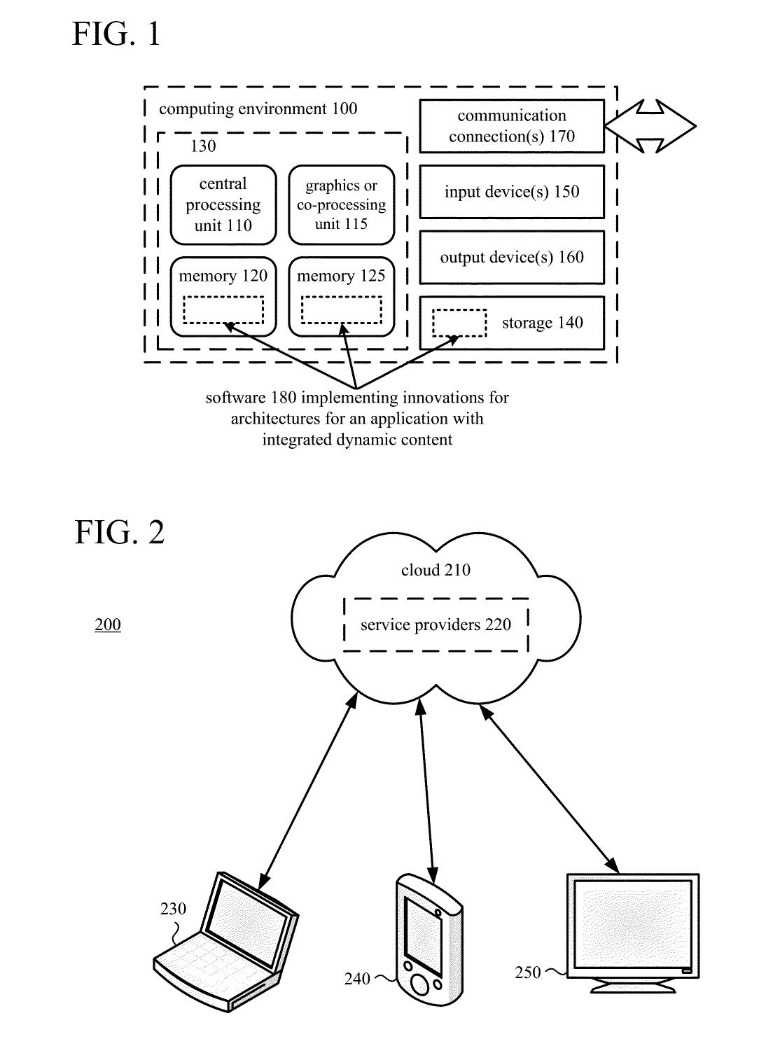

FIG. 1 illustrates a generalized example of an example computing system (100) in which several of the described innovations may be implemented. The computing system (100) is not intended to suggest any limitation as to scope of use or functionality, as the innovations may be implemented in diverse computing systems, including special-purpose computing systems adapted for an architecture for an application with an integrated dynamic content.

With reference to FIG. 1, the computing system (100) includes one or more processing units (110, 115) and memory (120, 125). The processing units (110, 115) execute computer-executable instructions. A processing unit can be a central processing unit (“CPU”), processor in an application-specific integrated circuit (“ASIC”) or any other type of processor. In a multi-processing system, multiple processing units execute computer-executable instructions to increase processing power. For example, FIG. 1 shows a central processing unit (110) as well as a graphics processing unit or co-processing unit (115). The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations for architectures for an application with integrated dynamic content, in the form of computer-executable instructions suitable for execution by the processing unit(s).

A computing system may have additional features. For example, the computing system (100) includes storage (140), one or more input devices (150), one or more output devices (160), and one or more communication connections (170). An interconnection mechanism (not shown) such as a bus, controller, or network interconnects the components of the computing system (100). Typically, OS software (not shown) provides an operating environment for other software executing in the computing system (100), and coordinates activities of the components of the computing system (100).

The tangible storage (140) may be removable or non-removable, and includes magnetic disks, magnetic tapes or cassettes, CD-ROMs, DVDs, or any other medium which can be used to store information and which can be accessed within the computing system (100). The storage (140) stores instructions for the software (180) implementing one or more innovations for architectures for an application with integrated dynamic content.

The input device(s) (150) may be a touch input device such as a keyboard, mouse, pen, or trackball, a voice input device, a scanning device, touchscreen, or another device that provides input to the computing system (100). The output device(s) (160) may be a display, printer, speaker, CD-writer, or another device that provides output from the computing system (100).

The communication connection(s) (170) enable communication over a communication medium to another computing entity. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available non-transitory, tangible media that can be accessed within a computing environment. By way of example, and not limitation, with the computing system (100), non-transitory computer-readable media include memory (120, 125), storage (140), and combinations of any of the above.

The innovations can be described in the general context of computer-executable instructions, such as those included in modules, being executed in a computing system on a target real or virtual processor. Generally, modules include routines, programs, libraries, objects, classes, components, data structures, etc. that perform particular tasks or implement particular abstract data types. The functionality of the modules may be combined or split between modules as desired in various embodiments. Computer-executable instructions for modules may be executed within a local or distributed computing system.

The terms “system” and “device” are used interchangeably herein. Unless the context clearly indicates otherwise, neither term implies any limitation on a type of computing system or device. In general, a computing system or device can be local or distributed, and can include any combination of special-purpose hardware and/or hardware with software implementing the functionality described herein. The disclosed methods can be implemented using specialized computing hardware configured to perform any of the disclosed methods. For example, the disclosed methods can be implemented by an integrated circuit (e.g., an ASIC such as an ASIC digital signal processor (“DSP”), a graphics processing unit (“GPU”), or a programmable logic device (“PLD”) such as a field programmable gate array (“FPGA”)) specially designed or configured to implement any of the disclosed methods.

For the sake of presentation, the detailed description uses terms like “request” and “use” to describe computer operations in a computing system. These terms are high-level abstractions for operations performed by a computer, and should not be confused with acts performed by a human being. The actual computer operations corresponding to these terms vary depending on implementation.

### II. Example Cloud Computing Environments.

FIG. 2 illustrates a generalized example of a cloud computing environment (200) in which several of the described innovations may be implemented. In the example environment (200), various types of services (e.g., computing services) are provided by a cloud (210). For example, the cloud (210) can comprise a collection of computing devices, which may be located centrally or distributed, that host dynamic Web pages for applications, store style sheet information and resources for applications, and provide other services for applications for various types of users and devices connected via a network such as the Internet. The computing devices of the cloud computing environment (200) can be used in different ways to accomplish computing tasks. For example, some tasks (e.g., processing user input, rendering a UI for an application, performing certain actions with applications) can be performed on local computing devices (e.g., connected devices 230, 240, 250), while other tasks (e.g., hosting dynamic Web pages or storing resources for applications) can be performed in the cloud (210).

In the example cloud computing environment (200), the cloud (210) provides services for connected devices (230, 240, 250) with a variety of screen capabilities. A first connected device (230) represents a device with a computer screen (e.g., a mid-size screen). For example, the first connected device (230) can be a personal computer such as desktop computer, laptop computer, notebook computer, netbook computer, or the like. A second connected device (240) represents a device with a mobile device screen (e.g., a small size screen). For example, the second connected device (240) can be a mobile phone, smartphone, personal digital assistant, tablet computer, and the like. A third connected device (250) represents a device associated with a large screen. For example, the third connected device (250) can be a television screen (e.g., a smart television) or another device connected to a television (e.g., a set-top box or gaming console) or the like. Devices without screen capabilities also can be used in the example cloud computing environment (200). For example, the cloud (210) can provide services for one or more computers (e.g., server computers) without displays. The way a UI of an application is rendered can depend on the screen capabilities of a computing system that presents the UI.

Services can be provided by the cloud (210) through service providers (220) or through other providers of online services (not depicted). Cloud services can be customized to the screen size, display capability, and/or touchscreen capability of a particular connected device (e.g., connected devices 230, 240, and/or 250). In the example cloud computing environment (200), the cloud (210) can provide services to host dynamic Web pages for applications, store resources for applications, and/or provide other services described herein, to the various connected devices (230, 240, and/or 250) using, at least in part, the service providers (220). In this case, the service providers (220) can provide a centralized solution for various cloud-based services. The service providers (220) can manage service subscriptions for users and/or devices (e.g., for the connected devices (230, 240, 250) and/or their respective users).

III. Example Architectures for an Application with Integrated Dynamic Content.

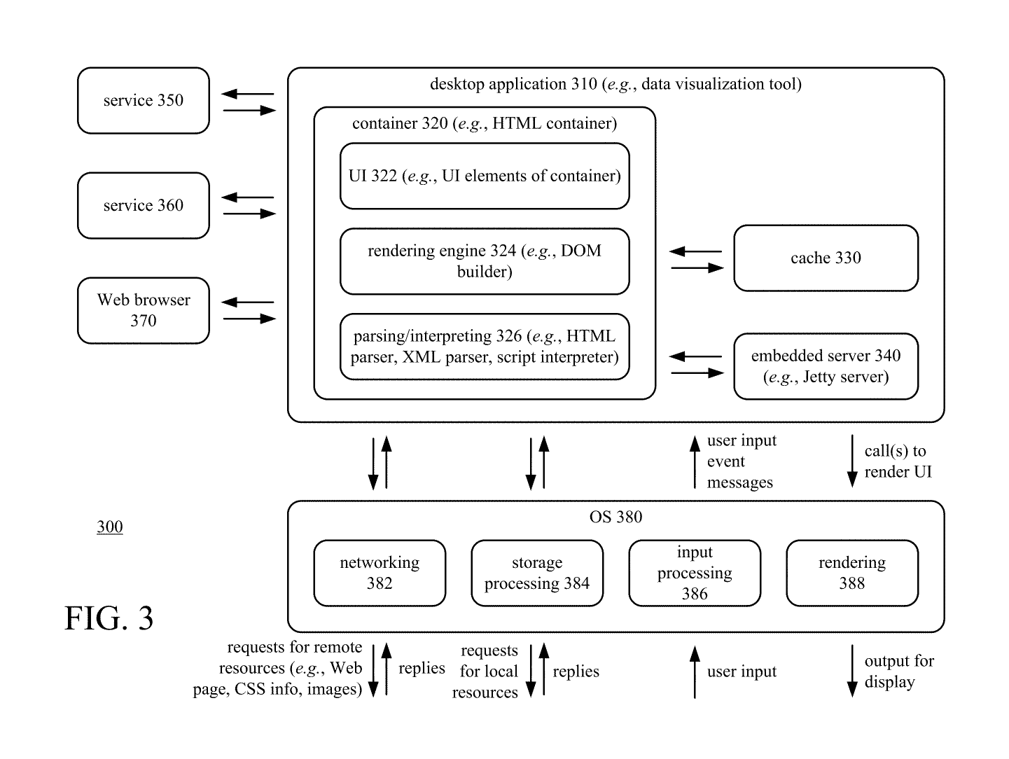

FIG. 3 shows an example software architecture (300) for an application with integrated dynamic content. A computing system (e.g., smartphone, tablet computer, personal computer, or other computing system) can execute software organized according to the architecture (300).

The architecture (300) includes an OS (380), a desktop application (310) that uses services of the OS (380), two other application-level services (350, 360), and a Web browser (370). In FIG. 3, the OS (380) includes components for rendering (e.g., rendering visual output to a display), components for networking, components for reading from/writing to storage, and components for input processing. Other components of the OS (380) are not shown. In general, the OS (380) manages user input functions, output functions, storage access functions, network communication functions, and other functions for the computing system. The OS (380) provides access to such functions to the desktop application (310) and other software running on the computing system (e.g., the other application-level services (350, 360) and/or the Web browser (370)).

In a networking module (382) of the OS (380), the OS (380) conveys requests for Web pages, live feeds, marketing feeds, related resources such as style sheet information or images, and/or other remote resources to one or more remote servers. The networking module (382) receives replies to the requests. The replies can provide, for example, Web pages, live feeds, marketing feeds, related resources and/or other remote resources. Typically, the desktop application (310) requests a dynamic Web page for an application. The dynamic Web page provides functionality for the UI of the desktop application (310), as described herein. In some special cases, however, the desktop application (310) may request a static Web page for the application (310).

In a storage processing module (384) of the OS (380), the OS (380) conveys requests for Web pages, related resources such as style sheet information or images, strings or other language-specific or locale-specific information, and/or other local resources to one or more local databases. The storage processing module (384) receives replies to the requests. The replies can provide, for example, Web pages, related resources such as style sheet information or images, strings or other language-specific or locale-specific information, and/or other local resources in a local database or the cache (330). The returned resources may be integrated into the desktop application (310) when rendered.

A user generates user input, which can be tactile input such as touchscreen input, mouse input, button presses or key presses, or can be voice input. In an input processing module (386) of the OS (380), the OS (380) includes functionality for recognizing taps, gestures, or other input to a touchscreen, recognizing commands from voice input, mouse input, button input or key press input, and creating messages that can be used by the desktop application (310). Through the container (320), the desktop application (310) listens for user input event messages from the OS (380). The user input event messages can indicate a gesture or tap on a touchscreen, mouse input, key press input, or another user input event (e.g., from voice input, directional buttons, trackball input). If appropriate, the desktop application (310) can react to the user input (or another type of notification) by making one or more calls to the OS (380) or performing other processing.

In a rendering module (388) of the OS (380), the OS (380) handles call(s) from the desktop application (310) to generate output for display. For example, the rendering module (388) renders a dynamic Web page or other dynamic content for an application, as specified in calls to graphics functions of the OS (380).

The desktop application (310) is, for example, a data visualization tool or business intelligence tool. Alternatively, the desktop application (310) is some other type of application. The desktop application (310) includes a container (320), a cache (330), and an embedded server (340). The container (320) is, for example, an HTML container. The container (320) includes a UI module (322), a rendering engine (324), and a parsing/interpreting module (326). Overall, the container (320) is configured to perform various operations described in this section, including requesting a Web page for the desktop application (310), requesting resources for the application (310), rendering the Web page (where the rendered Web page includes graphical elements of a UI of the application (310), and at least some of the elements of the UI are actuatable to launch services), handling user input to the application (310), and launching one of the services. Overall, the embedded server (340) is configured to perform various operations described in this section, including retrieving at least some of the requested resources for the application (310).

The UI module (322) of the container (320) controls UI elements of the container (320) and desktop application (310). For example, the UI module (322) controls menus, scroll bars and other “chrome” features of the desktop application (310) itself.

The rendering engine (324) builds a document object model (“DOM”) for a dynamic Web page or other dynamic content. In general, the DOM represents objects in the dynamic Web page or other dynamic content, as well as ways to interact with such objects. Conventionally, a DOM is organized as a tree structure in which nodes represent objects hierarchically. Objects in the DOM can be addressed, manipulated, or otherwise interacted with using functions defined on the objects. In many examples described herein, a user interacts with a dynamic Web page or other dynamic content through the DOM.

The parsing/interpreting module (326) parses and/or interprets code for dynamic Web pages, code for live feeds, code for marketing feeds, or other code for dynamic content, as well as style sheet information, images and other related resources for the dynamic content. The parsing/interpreting module (326) provides results of the parsing/interpreting to the rendering engine (324). The parsing/interpreting module (326) can include an HTML parser, XML parser, and/or other markup language parser. The parsing/interpreting module (326) can also include a JavaScript interpreter and/or other script interpreter. Thus, to render a Web page, the container (320) is configured to: (i) parse markup language code for the Web page (e.g., HTML code and/or XML code), (ii) create a DOM, and/or (iii) interpret script code for the Web page. For example, the Web page is a dynamic Web page defining the UI of the application (310) using HTML elements such as frames and content to be rendered in the frames, as well as scripting code such as client-side JavaScript code.

The cache (330) is configured to store Web pages (e.g., dynamic Web pages) and related resources for the desktop application (310). Before requesting a Web page or resource, the container (320) can be configured to check whether the cache (330) includes the Web page or resource. The container (320) can also be configured to check whether the Web page or resource has changed since being stored in the cache (330). If the cache (330) contains a current version of the Web page or resource, the container (320) can use the cached version of the Web page or resource, avoiding the extra steps of requesting and retrieving the Web page or resource. For additional details about this feature in example implementations, see section V.H.

The embedded server (340) handles calls from the container (320) to retrieve resources from a local database or other local source. The embedded server (340) retrieves the requested resources, if available, and provides retrieved resources to the container (320). The embedded server (340) is, for example, a Jetty server or other server that provides Web server functionality and/or script servlet functionality (e.g., Java servlet functionality) for the desktop application (310). The container (320) and embedded server (340) can communicate using HTTP or another protocol.

For localization, the container (320) determines a language or locale for the desktop application (310), e.g., based on a setting for the desktop application (310) or preference selection by the user. The embedded server (340) can play a role in localization of the desktop application (310). For example, the embedded server (340) is configured to receive an indication of language or locale (from the container (320)) and, based on the indication of language or locale, retrieve strings of text elements of the UI of the application (310). The embedded server (340) is further configured to return the strings to the container (320), which uses the strings when rendering the Web page. If necessary, the application (310) can be re-started to change the language or locale for the application (310). For additional details about this feature in example implementations, see section V.C.

The container (320) can be configured to, at startup, request an initial version of the Web page from the embedded server (340) and/or request a current version of the Web page from a remote server. For example, when a desktop application that integrates a dynamic Web page is launched, the container (320) and embedded server (340) are started. The application (310) requests the container (320) to open a URL for the dynamic Web page. Initially, the URL can be a local, startup page that the embedded server (340) retrieves from a local database for processing by the parsing/interpreting module (326) of the container (320). The user can also navigate to a home screen of the application (310), which is specified in a dynamic Web page that the container (320) retrieves from the cache (330) or a remote server. The container can then parse the dynamic Web page, create a DOM for the dynamic Web page, and execute script code to manage interactions between the user and the DOM for the dynamic Web page. The content of the dynamic Web page may subsequently change over time in response to user input or in response to updates from a server (e.g., for a live feed or marketing feed).

After processing by the parsing/interpreting module (326) of the container (320) and rendering by the rendering engine (324) of the container (320), the home screen can show various graphical elements (such as buttons) that a user can actuate to launch services of the desktop application (310). The services can include, for example, a live chat service, data acquisition service, help service, and/or other service. Some of the services can be provided using the Web browser (370), which can also be used to access an arbitrary external Web link in the dynamic Web page. FIG. 3 shows two services (350, 360). Alternatively, the desktop application (310) can be capable of launching more or fewer services. The user can actuate other graphical elements of the home screen to cause the desktop application (310) to perform other operations of the desktop application (310). To handle user input, the container (320) is configured to receive a user input event. The container (320) is further configured to pass the user input event to one of the services or another component of the desktop application (310), or process the user input event in the container (320) (e.g., launching a service, performing a desktop operation). When processing a user input event, the container (320) can call one or more internal methods defined for the DOM.

The container (320) can control access to the functionality of the desktop application (310) in various ways. For example, the container (320) is configured to declare a script function in the DOM, initialize an operation of the application (310), and, in response to invocation of the operation of the application (310) within the container, call the script function to perform the operation. In contrast, invocation of the operation by a Web browser fails to call the script function to perform the operation. For additional details about this feature in example implementations, see section V.E. As another example, the container (320) is configured to generate an authentication token when initializing the application (310), pass the authentication token to a client (e.g., one of the services or a desktop client), receive a request to invoke a script function defined in the DOM, and check that the request is accompanied by the authentication token as a condition of invoking the script function. For additional details about this feature in example implementations, see section V.E. As another example, the container (320) is configured to check whether an external Web link corresponds to a script function defined in the DOM and, if so, invoke the script function to launch a service to de-reference the external Web link, but otherwise launch a new browser window to de-reference the external Web link. For additional details about this feature in example implementations, see section V.G.

The UI of the desktop application (310) can change depending on the form factor of the computer system or window size for the application (310). For example, the container (320) is configured to request style sheet information for the application (e.g., from a local database or remote server, after checking the cache (330) for the style sheet information). The style sheet information can specify different layouts for the UI of the application (310) for different form factors or window sizes. The container (320) is also configured to evaluate configuration information for a display device or window (e.g., width and/or height, resolution). To render the Web page, the container (320) is configured to set the layout (e.g., layout of the UI) of the desktop application (310) based on one or more fields (e.g., media tags) of the style sheet information and based on the configuration information for the display device or window. For additional details about this feature in example implementations, see section V.B.

The container (320) can handle various types of errors so that the application (310) continues to function, even if functionality is limited or degraded. For example, the container (320) is configured to detect an error condition, which can be a network error condition, service error condition, or application error condition, and request a standby version of the Web page from the embedded server (340) instead of a dynamic Web page for the application. The standby version of the Web page can be a static Web page or dynamic Web page with limited, degraded functionality. For additional details about this feature in example implementations, see section V.D. Or, as another example, the container (320) is configured to detect an error condition for a given service and request an offline version of the given service from the embedded server (340). For example, the offline version of the given service is a static Web page. For additional details about this feature in example implementations, see section V.D.

Alternatively, the OS (380) includes more or fewer modules. Or, the desktop application (310) includes more or fewer modules. A given module can be split into multiple modules, or different modules can be combined into a single module. For example, the container (320) can be implemented as multiple modules, with the parsing/interpreting module (326) being independent of the other modules of the container (320).

IV. Example Techniques for Presenting an Application with Integrated Dynamic Content.

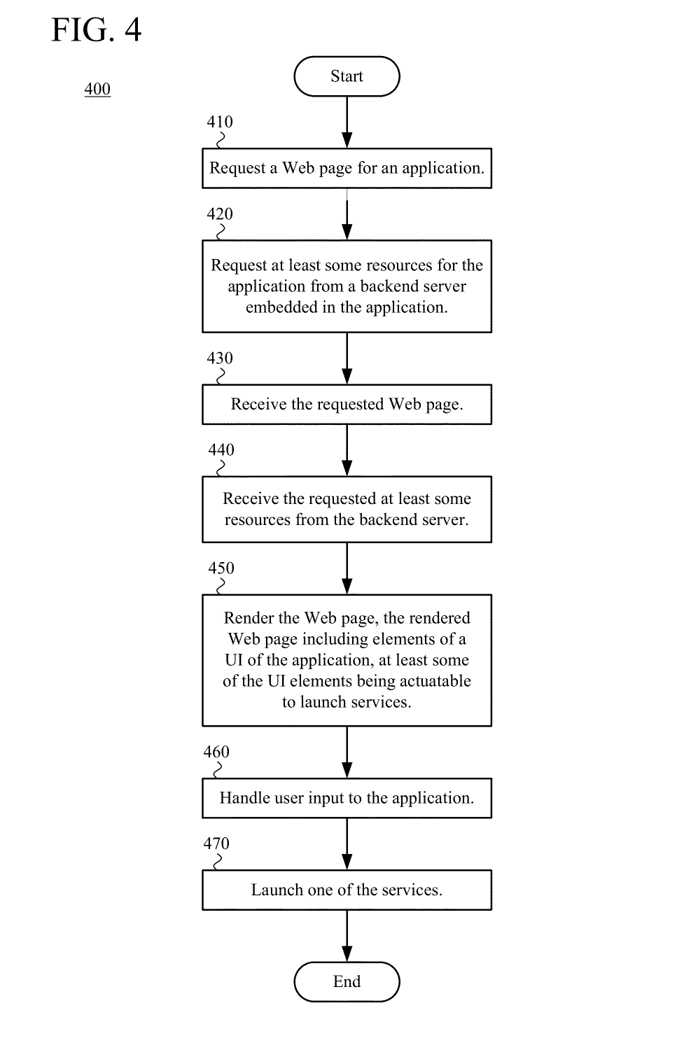

FIG. 4 shows a generalized technique (400) for presenting an application with integrated dynamic content. The technique (400) can be performed by a container as described with reference to FIG. 3 or by another component of an application.

The container requests (410) a Web page for an application and also requests (420) at least some resources for the application from a backend server embedded in the application. For example, the container requests the Web page and resources using mechanisms described in the previous section.

The container receives (430) the requested Web page. The container also receives (440) the requested at least some resources from the backend server. The container renders (450) the Web page, which includes elements of a UI of the application. At least some of the elements of the UI are actuatable (can be actuated by the user) to launch services. The container handles (460) user input to the application and, in response to certain user input, launches (470) one of the services. When configured appropriately, the container and/or backend server can perform various other operations as described in the previous section.

V. Features of Example Architectures for a Desktop Application with Integrated Dynamic Content.

This section describes various features of architectures for a desktop application with integrated dynamic content. The various features include, but are not limited to: (1) integrating a dynamic Web page into a desktop application; (2) making the desktop application responsive and resizable; (3) adapting the desktop application to different languages and locales; (4) handling errors at the container level of the desktop application; (5) handling security risks that may arise from exposed script functions in a DOM by limiting access to the script functions and/or using authentication tokens; (6) supporting live chat in the desktop application; (7) launching arbitrary Web pages from the desktop application; and (8) using a cache to improve performance of the desktop application. In summary, the various features provide efficient, easily pluggable, low-maintenance, responsive, scalable architectures which can be used with an arbitrary desktop application. The various features can be implemented in combination or separately.

A. Integrating a Dynamic Web Page into a Desktop Application.

A conventional desktop application (standalone application) does not integrate a dynamic Web page, live feed, marketing feed, or other dynamic content. Also, architectures for conventional desktop applications do not facilitate discovery of information about actual usage of a desktop application or facilitate alerting users about available updates to the desktop application. Further, architectures for conventional desktop applications do not quickly adapt to user feedback.

According to one aspect of the features described herein, a generic, pluggable architecture facilitates integration of a dynamic Web page, live feed, marketing feed, or other dynamic content into a desktop application. An arbitrary desktop application can be implemented using the architecture. The architecture is not tied to any specific technology product or platform.

For example, a URL is provided for a dynamic Web page. In the architecture, a container retrieves and renders the dynamic Web page without any constraint on the content of the dynamic Web page. The container can thus support an arbitrary desktop application whose UI is specified with a dynamic Web page. Also, changes to the UI of a given desktop can be made as changes to the dynamic Web page for the desktop application, simplifying the process of making and distributing updates to the application. The container can switch desktop applications by switching dynamic Web pages.

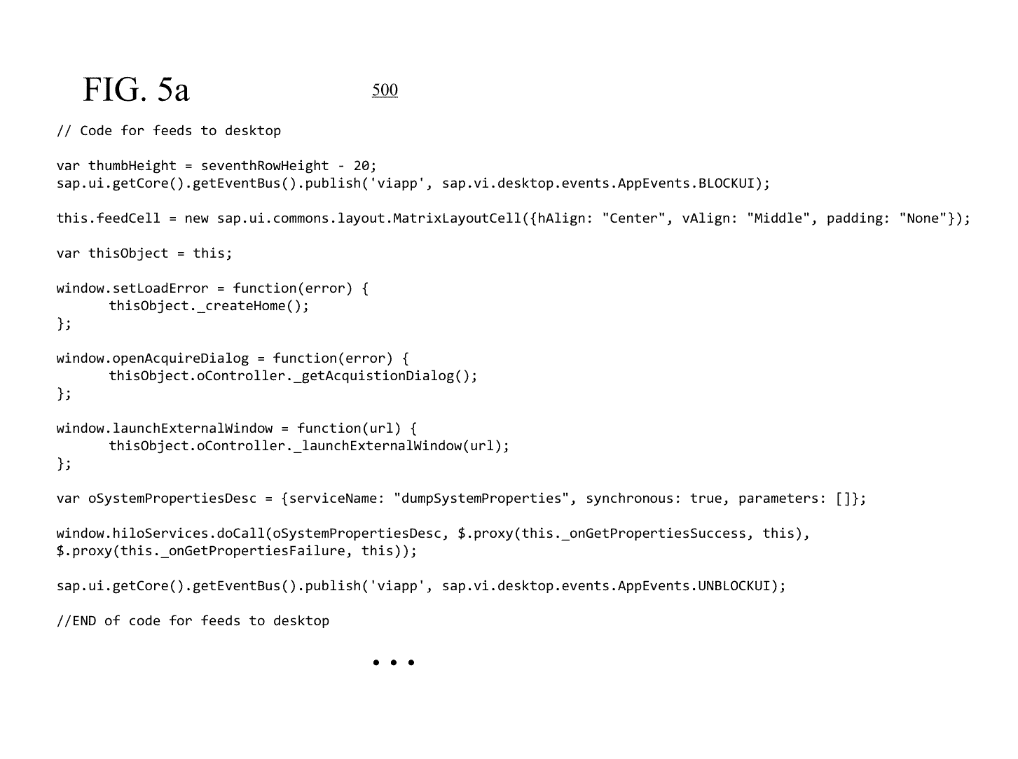

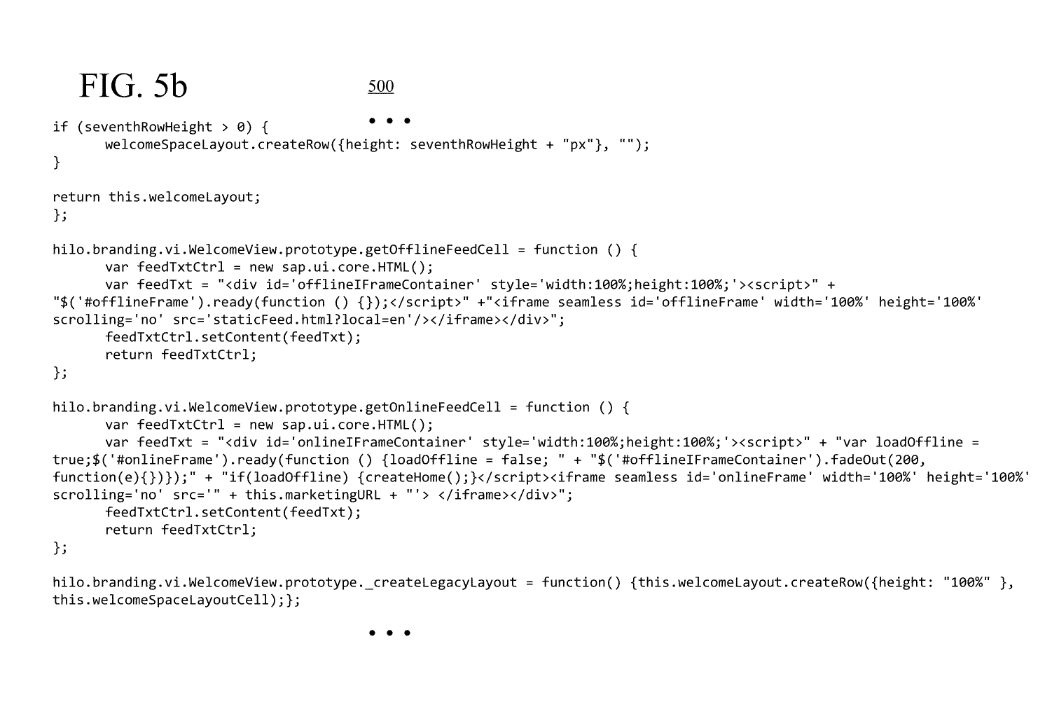

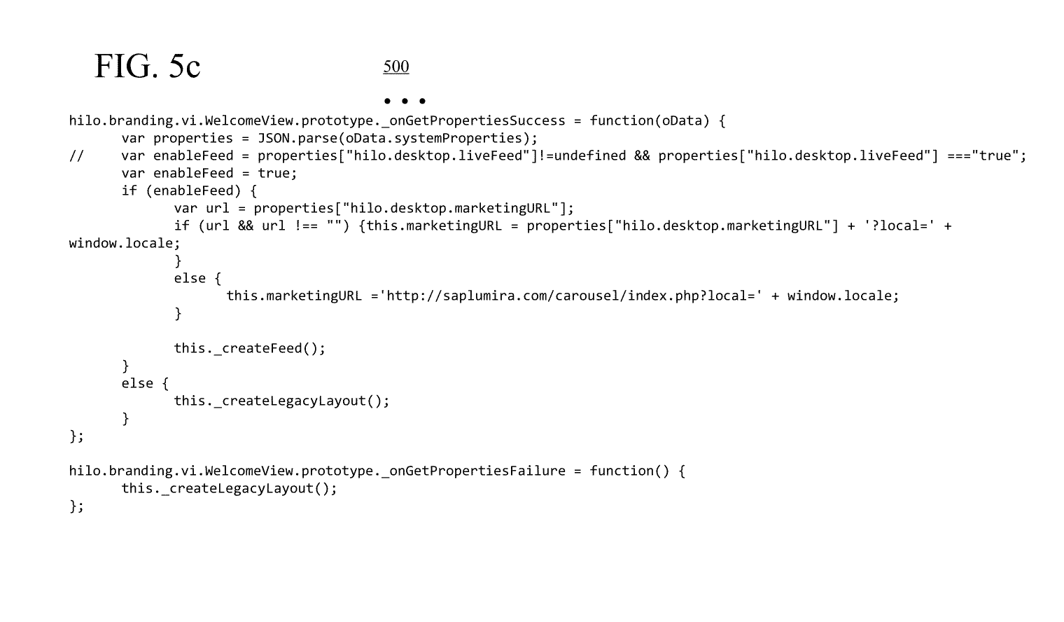

FIGS. 5a-5c are a pseudocode listing (500) of examples of functions and other statements used when integrating dynamic content into an application. In the pseudocode listing, a desktop application uses a dynamic Web page (in FIG. 5c, the page http://saplumira.com/carousel/index.php) to provide a feed to a frame for the UI of the desktop application. The content of the UI of the desktop application can be changed by changing the URL for the dynamic Web page.

B. Supporting Resizing and Responsive Behavior for the Desktop Application.

According to another aspect of the features described herein, a desktop application with integrated dynamic content handles resizing and supports responsive behavior. The desktop application is responsive at different resolutions, e.g., by calculating screen size and rendering the application appropriately. The screen size can depend on a display device or window size for the desktop application.

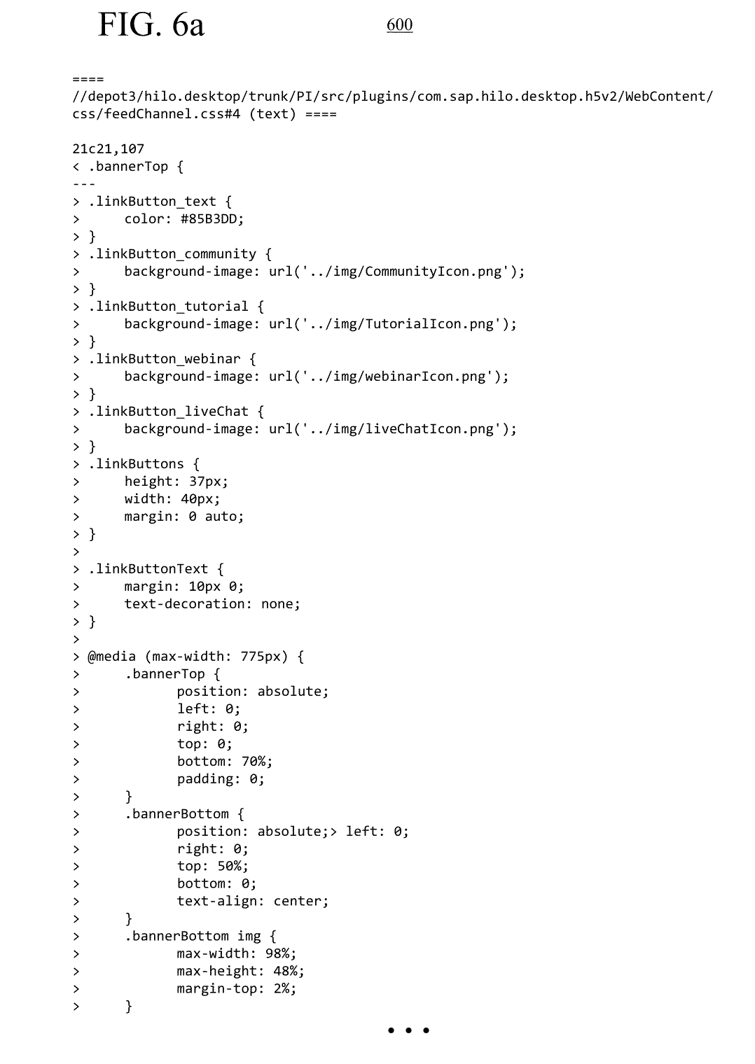

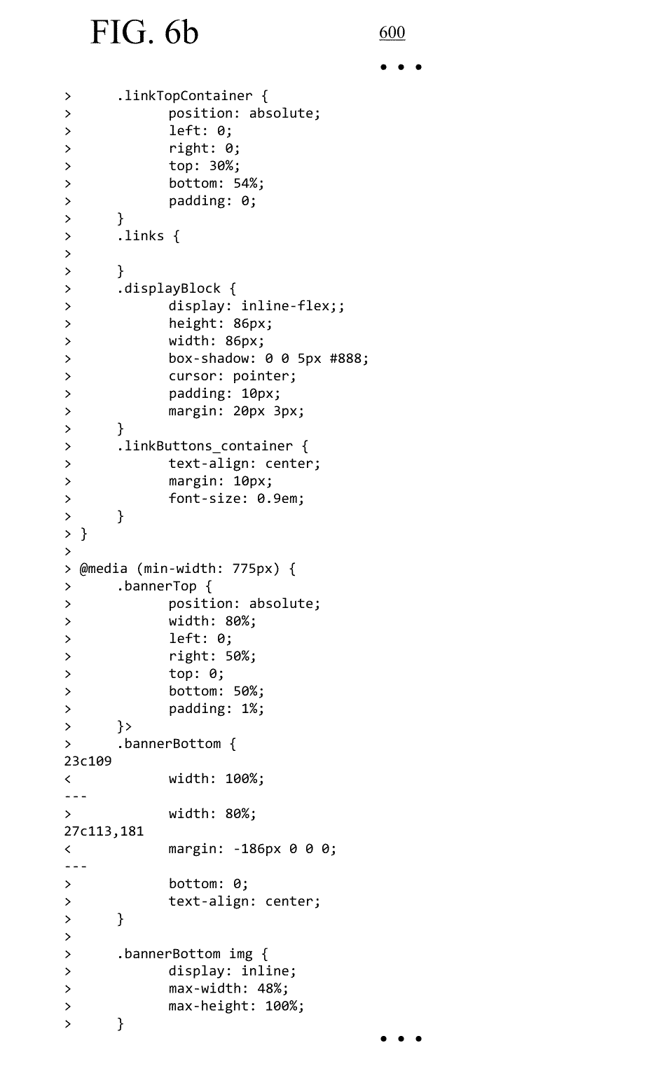

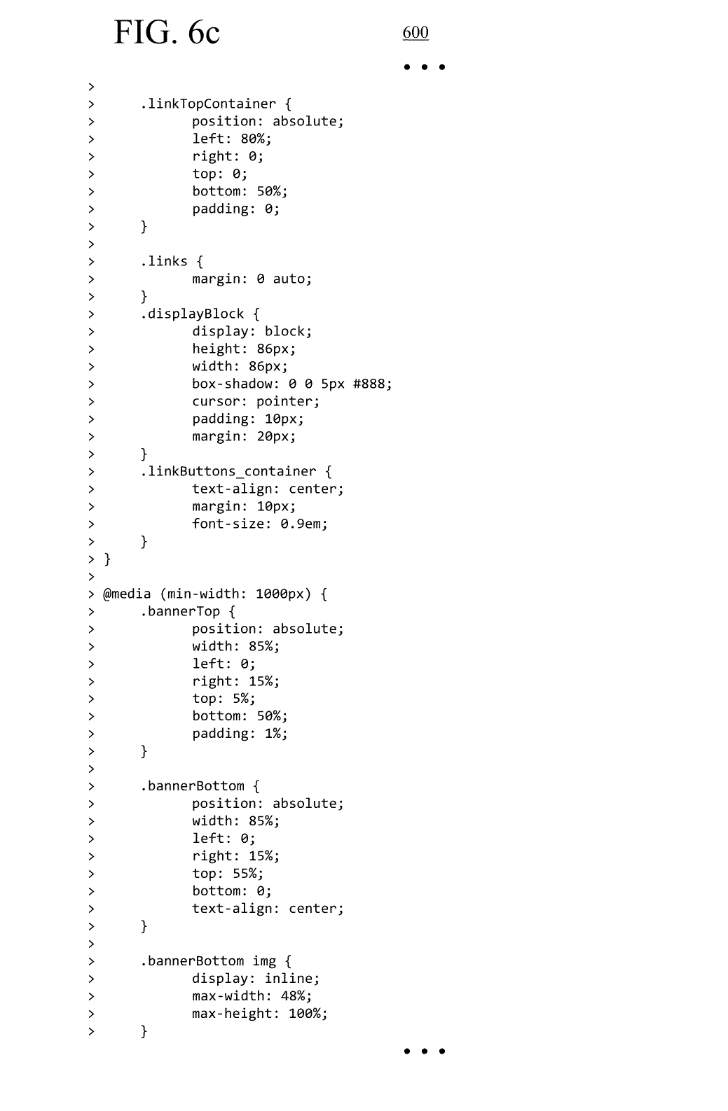

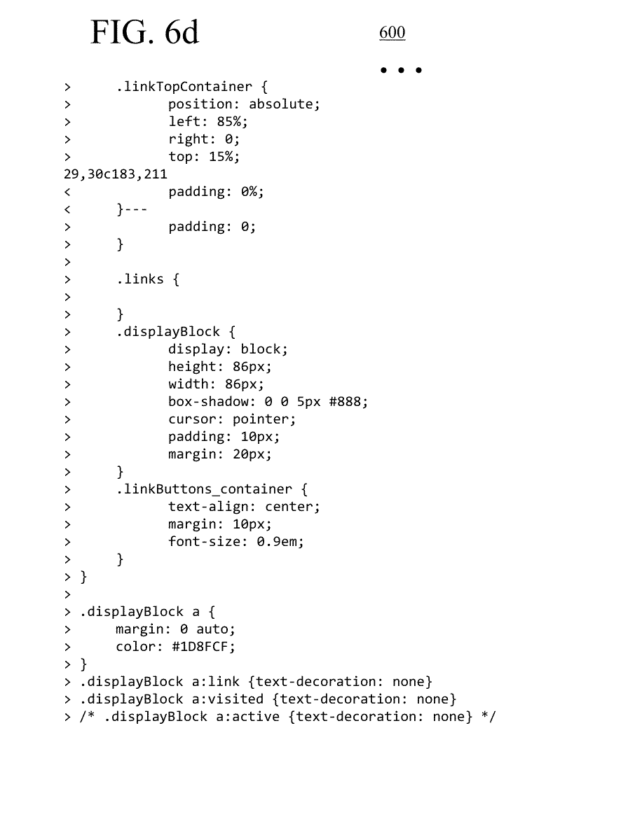

FIGS. 6a-6d are a pseudocode listing (600) of example style sheet information that can be used to adapt presentation of a desktop application with integrated dynamic content. The style sheet information is in a cascading style sheet (“CSS”) file. For a given display characteristic (as shown in the media tags), the style sheet information defines settings for UI elements (such as .bannerTop, .bannerBottom, .bannerBottom img, .linkTopContainer, .displayBlock, .linkButtons_container).

C. Localizing the Desktop Application.

According to another aspect of the features described herein, a desktop application that integrates a dynamic Web page or other dynamic content adapts to different languages and locales. The language or locale may be set in settings in a browser, in preferences of the desktop application, or in user preferences. A container is passed information indicating the appropriate locale and language for a dynamic Web page for the desktop application. The container requests data objects appropriate for the selected language/locale from the embedded server, then uses the retrieved data objects when rendering the dynamic Web page or other dynamic content.

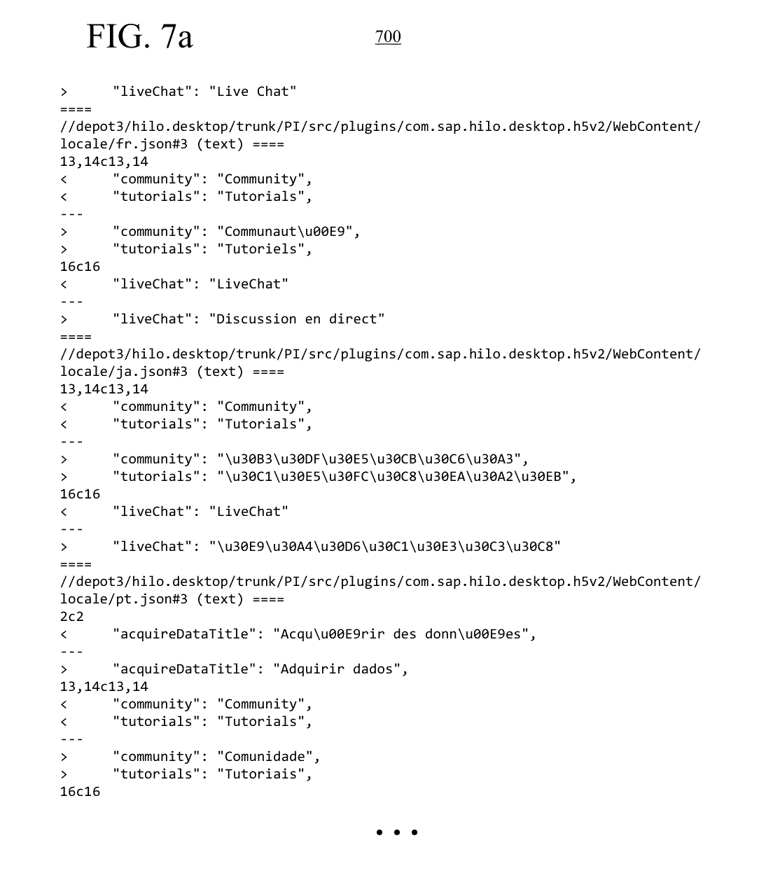

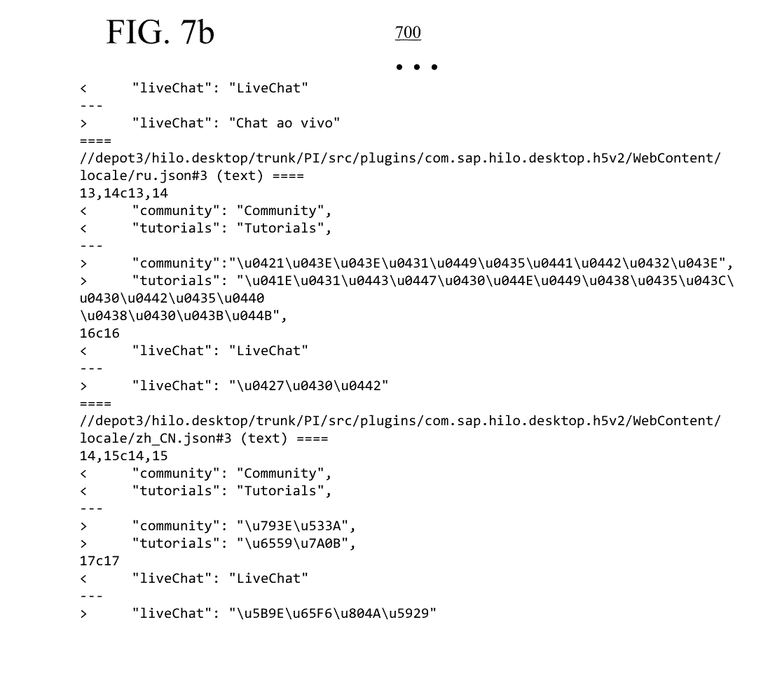

FIGS. 7a and 7b are a pseudocode listing (700) of examples of data objects used to localize the UI of an application with integrated dynamic content. The data objects are in JavaScript object notation (“JSON”) format. The data objects indicate translations of strings such as “community,” “tutorial,” and “live chat” for French, Japanese, Portuguese, Russian, and Chinese. In the UI of the desktop application, the appropriate strings for the selected language/locale are presented when the dynamic Web page is rendered.

D. Handling Errors at Container Level for the Desktop Application.

According to another aspect of the features described herein, a desktop application that integrates a dynamic Web page or other dynamic content handles errors at the container level. Various error scenarios/conditions are handled. At the container level, the desktop application can handle an arbitrary error condition such as a network connection problem, a problem with a remote Web server, or a domain name lookup problem by retrieving and rendering a static Web page. The desktop application continues to work when the error condition is encountered, although functionality may be limited or degraded (e.g., some desktop operations or services disabled).

For example, if the container is unable to launch a Web browser to de-reference a URL, or if the referenced Web page does not load for any reason, the container detects an error condition (even if the actual loading happens at the script level (e.g., JavaScript level)). For this purpose, the architecture can include a callback interface implemented by the container. When the container detects an error condition, a static Web page is retrieved (e.g., from a local database using an embedded server, or from a cache) and rendered by the container.

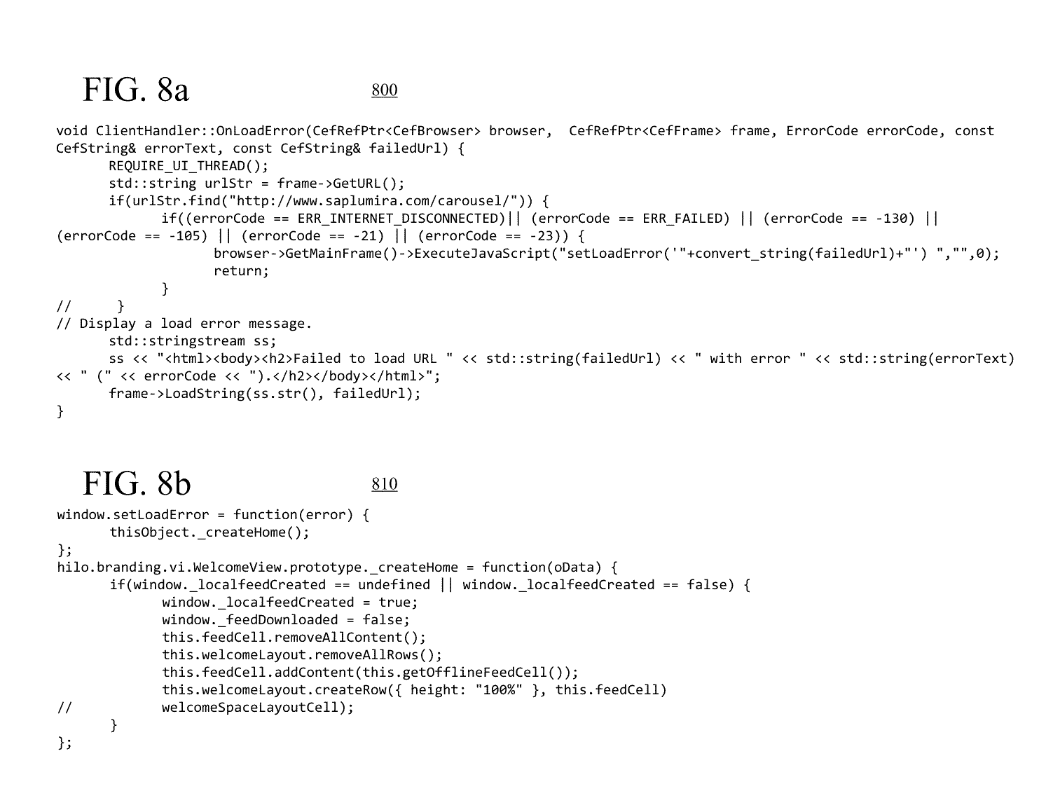

FIGS. 8a and 8b are pseudocode listings (800, 810) of examples of functions and other statements used when handling error conditions in a desktop application with integrated dynamic content. In particular, FIG. 8a shows C++ code for the container-side function OnLoadError, which is invoked when there is an error loading a URL. FIG. 8b shows JavaScript code for a corresponding script-side function, which is invoked by the container when the container encounters a load error.

As another example, the desktop application handles cases in which network access is unavailable, even when a dynamic Web page defines the UI of the desktop application. The desktop application continues to work in this situation, but the container loads and renders a static Web page, which defines a UI similar to the one defined in the dynamic Web page. Functionality of the desktop application may be limited or degraded (e.g., some desktop operations or services disabled). The desktop application remains responsive to user input, however.

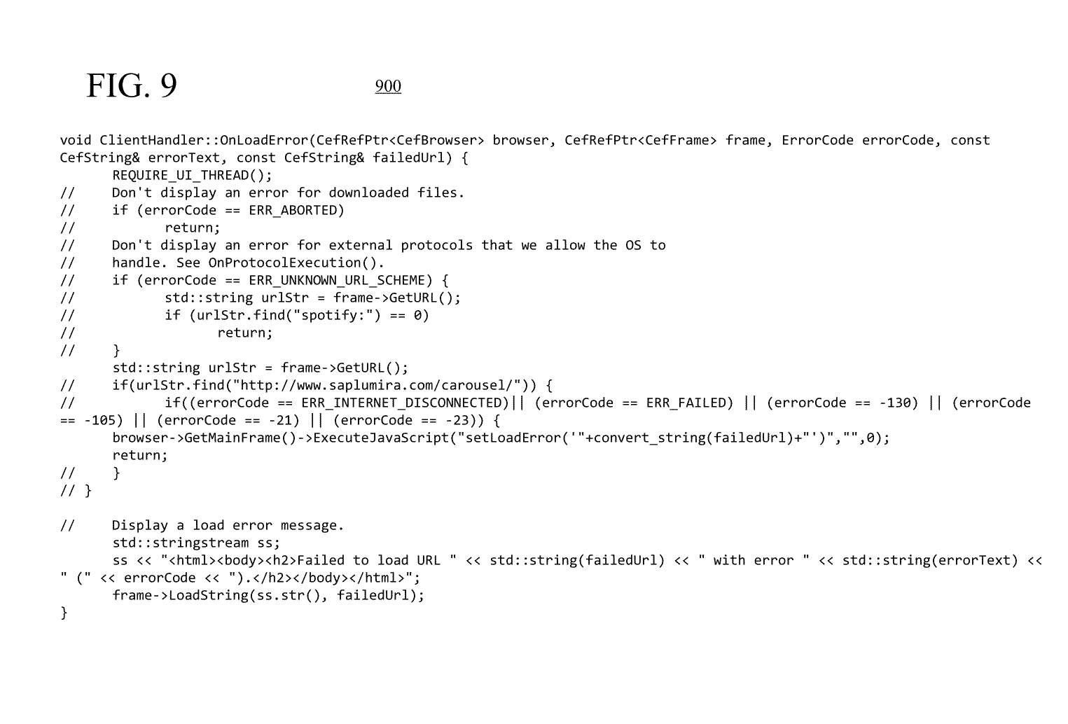

FIG. 9 is another pseudocode listing (900) of an example of function used when handling error conditions in a desktop application with integrated dynamic content. In particular, FIG. 9 shows C++ code for another version of the container-side function OnLoadError, which is invoked when network access is unavailable (and hence there is an error loading a URL). FIG. 8b shows JavaScript code for a corresponding script-side function, which is invoked by the container when network access is unavailable.

E. Handling Security Risks from Exposed Script Functions.

A desktop application that integrates a dynamic Web page or other dynamic content can support arbitrary desktop operations defined for the desktop application. This potentially creates security risks.

According to another aspect of the features described herein, a desktop application handles security risks stemming from the exposure of script functions in a DOM by managing access to the script functions. For example, when the desktop application is loaded, the container declares a script function (e.g., a JavaScript function) in a DOM. Before loading a dynamic Web page, the container lacks any knowledge of the dynamic Web page or operations defined in the dynamic Web page. When the dynamic Web page is loaded from the container, the container parses code (such as code in HTML and/or XML) that specifies operations for the desktop application, and the container initializes the desktop operations. In operation, if one of the desktop operations initialized by the container is invoked, the appropriate script function defined in the DOM for the desktop application is invoked.

On the other hand, if the same dynamic Web page is directly accessed from a Web browser, the script function in the DOM is not invoked. The script function declared by the container in the DOM is not declared by the Web browser. Therefore, the script function will be undefined, and nothing will happen when the desktop operation is invoked through the dynamic Web page as rendered in the Web browser.

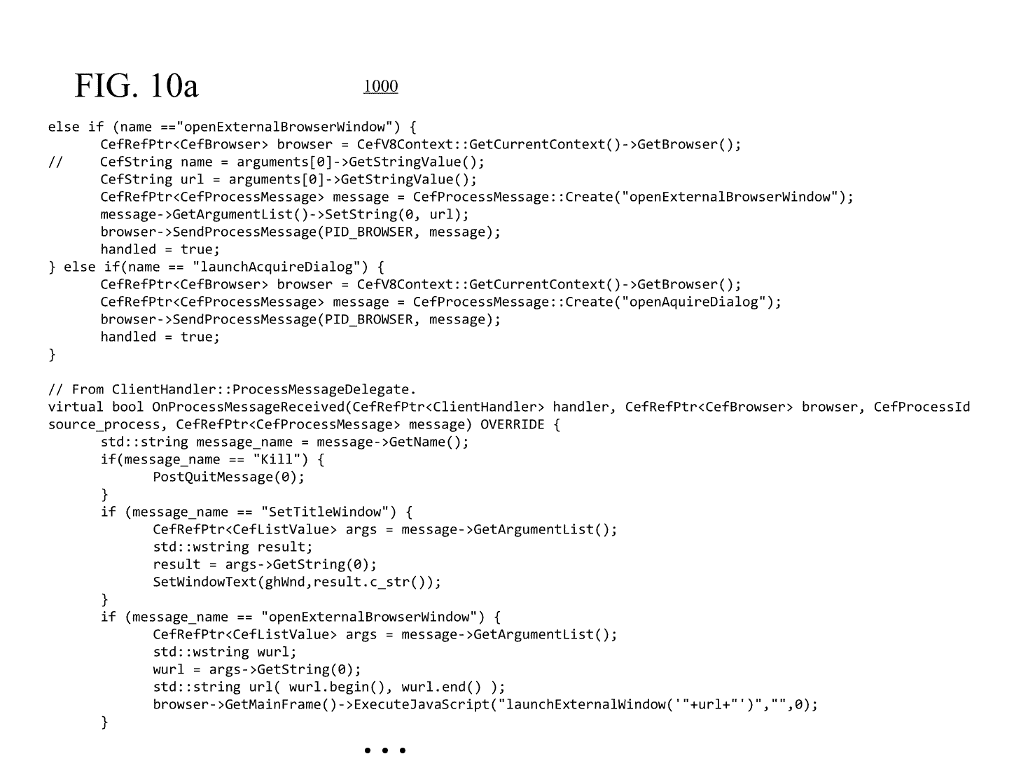

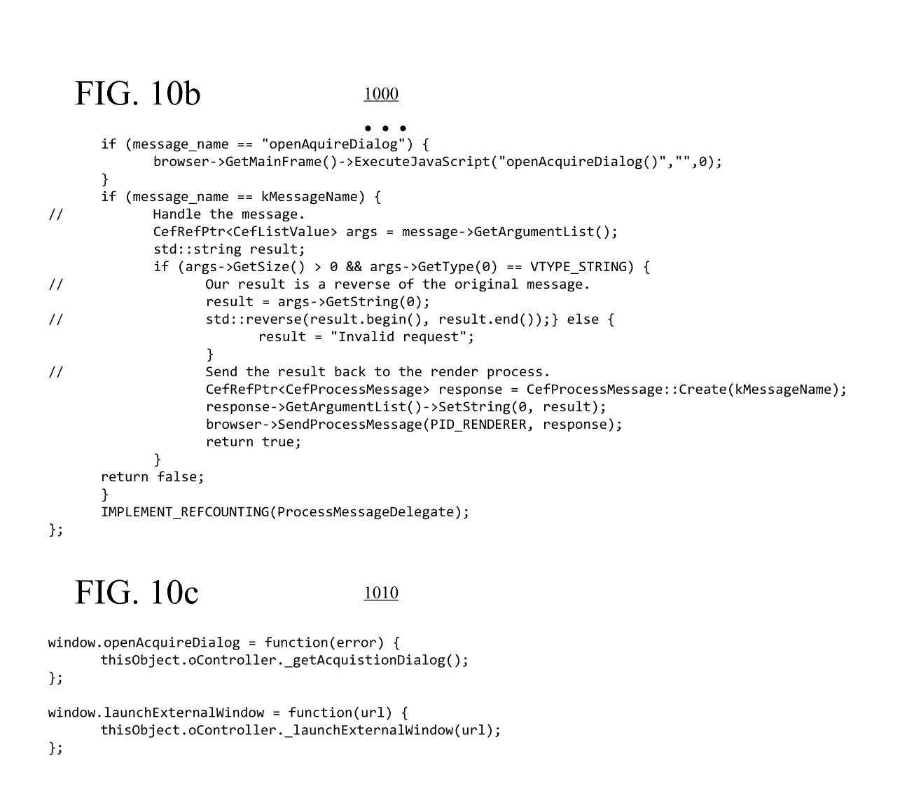

FIGS. 10a-10c are pseudocode listings (1000, 1010) of examples of functions and other statements used when controlling access to script functions of a DOM for an application with integrated dynamic content. FIGS. 10a and 10b show conditional statements and a function OnProcessMessageReceived that process various types of messages, include messages named “openExternalBrowserWindow” and “launchAcquireDialog”/“openAcquireDialog” that correspond to script functions. When such messages are received and processed, one of the script functions shown in FIG. 10c is called (that is, the script function “openAcquireDialog” or “launchExternalWindow” is called). For example, when the user actuates a button or other graphical element of the UI to perform the operation “Acquire Data” in the container context, the desktop operation is processed as a message “launchAcquireDialog,” which is converted into a message “openAcquireDialog,” which causes the container to call the script function “openAcquireDialog” defined in the DOM. On the other hand, if the same UI element is actuated when the Web page is rendered in a Web browser context, the script function is not invoked.

Exposing and accessing script functions (e.g., native JavaScript functions) across a DOM can create security risks. If a script function is exposed in the DOM, a malicious user can write code for a spoof Web site and, from there, potentially fool the container to execute malicious functions.

According to another aspect of the features described herein, a desktop application handles security risks stemming from the exposure of script functions in a DOM by using authentication tokens to authenticate requests to invoke the script functions. This can provide security around access of native script functions (such as JavaScript functions) exposed in a DOM.

For example, when a container exposes script functions in a DOM (e.g., when launching the desktop application), the container generates an authentication token (unique identifier). The container passes the unique identifier to a desktop client (such as the desktop application) that is authorized to invoke the script functions, which otherwise may be globally available. The desktop client can, in turn, use the unique identifier whenever the desktop client invokes any function through a globally available script which calls the container again. Using the unique identifier conveyed with a request, the container can check whether the request is a valid (authorized) request. Based on results of the check, the container will either reject the request or proceed with accepting/executing the request by invoking the script function in the DOM.

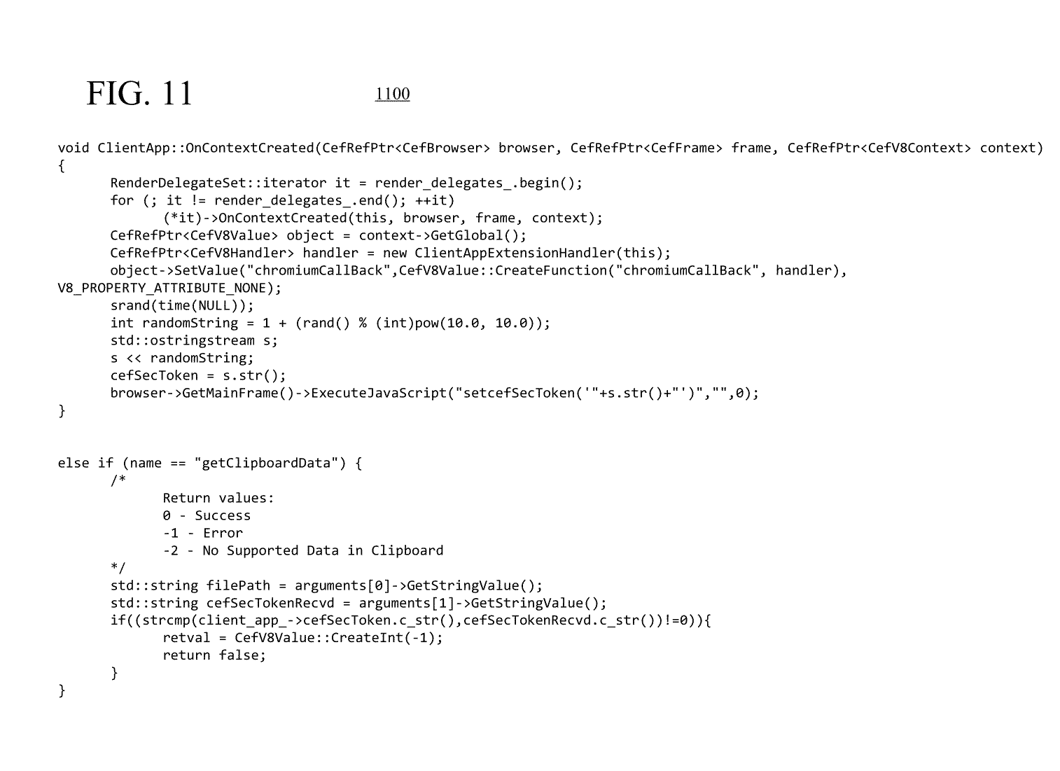

FIG. 11 is a pseudocode listing (1100) of examples of functions and other statements used for authentication in a desktop application with integrated dynamic content. FIG. 11 shows a function “OnContextCreated” in which an authentication token cefSecToken is generated and passed. FIG. 11 also shows statements in which an authentication token is received as an argument for a request, then compared to a stored value of the authentication token. An error condition is triggered if the received value does not match the stored value of the authentication token.

F. Supporting Live Chat in the Desktop Application.

A conventional desktop application (standalone application) does not support live chat. Live chat may have different constraints in different countries. Connecting live chat from a desktop application is challenging because live chat involves network access and handling various special cases for different countries.

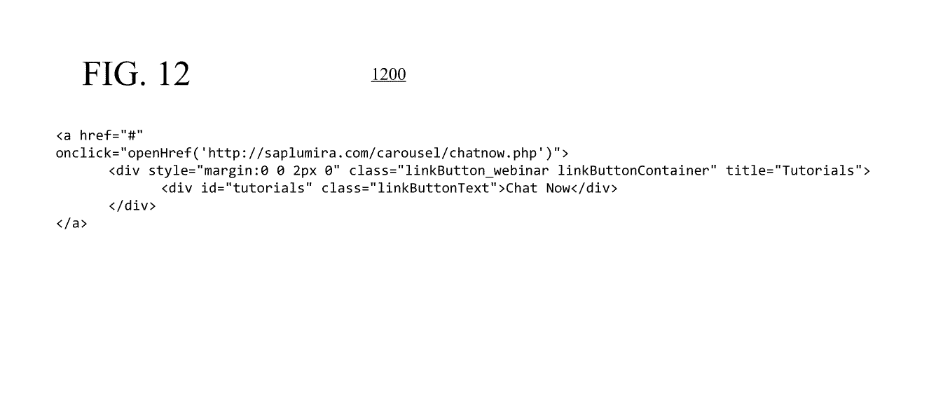

According to another aspect of the features described herein, a desktop application that integrates a dynamic Web page or other dynamic content supports live chat. For example, the live chat is provided as a service that can be launched from the desktop application. FIG. 12 is a pseudocode listing (1200) of statements used to define a control for launching a live chat service in a desktop application with integrated dynamic content.

G. Launching Arbitrary Web Pages from the Desktop Application.

Aside from links for desktop operations, an integrated dynamic Web page for a desktop application may have links to open other URLs. According to another aspect of the features described herein, an external Web link can be accessed using a desktop application container or Web browser. Whether such links are accessed using the container for the desktop application or an external Web browser as the underlying engine, the behavior should be the same. That is, if a Web page is an external link, the Web page is handled and works as expected, whether the Web page is accessed using a Web browser or desktop application.

For example, in the desktop application, the container initializes a callback script function (e.g., JavaScript function) to launch a browser window from the context of the container. When a Web page is launched in the container context, the callback function can be called from a given container function defined in the DOM by the container. Specifically, when a Web page is accessed, client-side script code checks whether the container has defined the given container function. If so, the given container function defined in the DOM by the container is invoked, which calls the callback script function, which calls other code to launch a new browser window in the container context. Otherwise, the client-side script code launches a normal new Web browser window to render the Web page.

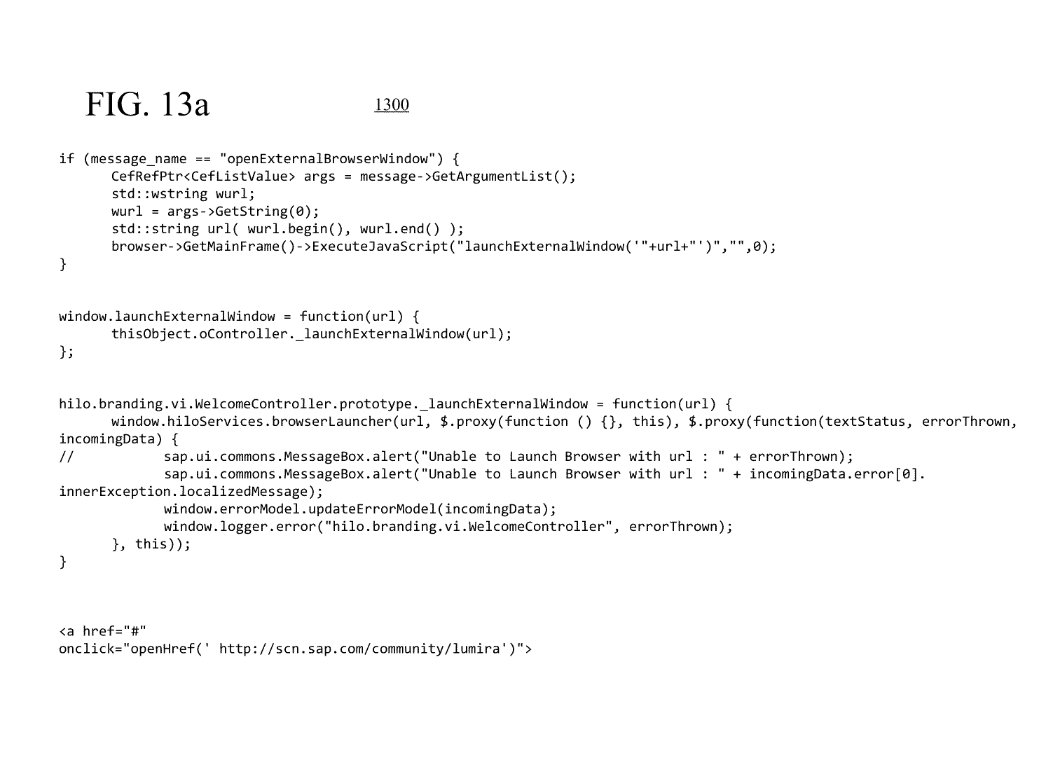

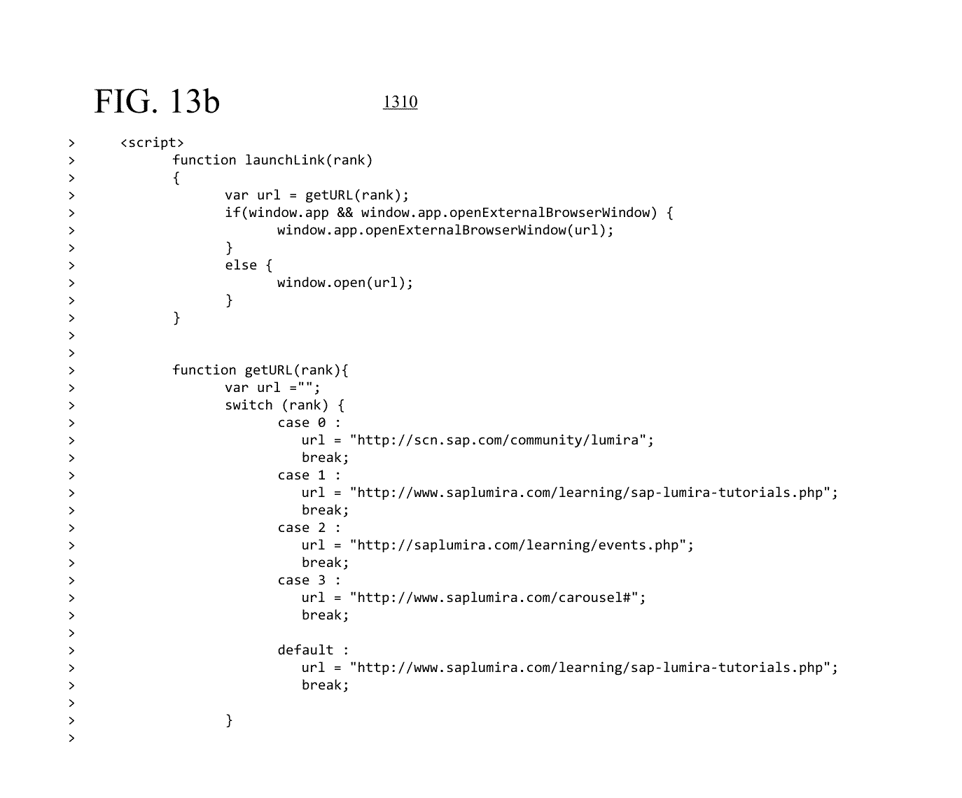

FIGS. 13a and 13b are pseudocode listings (1300, 1310) of examples of functions and other statements used when processing an external Web link in a desktop application with integrated dynamic content. FIG. 13a shows a callback script function launchExternalWindow as well as part of a container function that calls the callback script function. The callback script function in turn calls another function_JaunchExternalWindow, which launches a browser in the container context. FIG. 13b shows client-side script code that checks whether the container function openExternalBrowserWindow is defined. If so, the container function is called with a URL. Otherwise, a normal browser window is opened to render the URL. The URL is returned from the function getURL, which determines a URL based on a “rank” input (e.g., from user input to a graphical control).

H. Using a Cache to Improve Performance of the Desktop Application.

Integrating dynamic content into a desktop application can introduce delays due to network lag for retrieval of content from remote servers. Such delays can make the desktop application seem less responsive to a user. Also, retrieving content redundantly is inefficient in terms of network bandwidth utilization.

According to another aspect of the features described herein, a desktop application uses a cache to improve performance. The cache stores Web pages and related resources for the desktop application. The desktop application downloads content such as a Web page or related resource only when there has been a change to the content or a duration value for the content has expired. Otherwise, the application does not download the content, thereby avoiding the performance cost of re-retrieving and re-rendering the content.

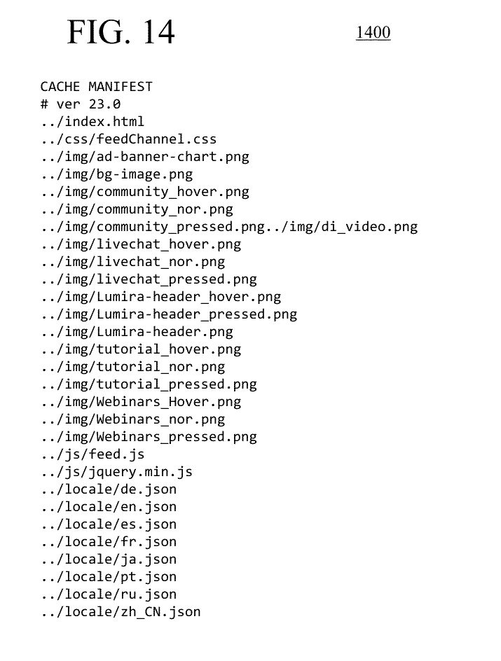

FIG. 14 is a pseudocode listing (1400) of example files in a cache in an architecture for a desktop application with integrated dynamic content. The example files include a home page (index.html), style sheet information (feedChannel.css), various image files (.png files) for graphics, client-side script code (.js files), and data object files for localization (.json files).

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer system comprising a processor, memory, and storage that implements an application architecture, the application architecture comprising:
a container configured to:
request a Web page for an application;
request resources for the application;
render the Web page, wherein the rendered Web page includes graphical elements of a user interface of the application, at least some of the elements of the user interface being actuatable to launch services;
handle user input to the application; and
launch one of the services; and
a backend server embedded in the application, the backend server being configured to retrieve at least some of the requested resources for the application.

2. The computer system of claim 1, wherein, to render the Web page, the container is further configured to:
parse markup language code for the Web page, wherein the markup language code includes one or more of hypertext markup language code and extensible markup language code;
create a document object model; and
interpret script code for the Web page.

3. The computer system of claim 1, wherein the services include one or more of a service to acquire data, a chat service, and a help service.

4. The computer system of claim 1, wherein, to request the Web page, the container is configured to, at startup, request a current version of the Web page from a remote server.

5. The computer system of claim 1, wherein, to request the Web page, the container is configured to, at startup, request an initial version of the Web page from the backend server.

6. The computer system of claim 1, wherein the container is further configured to:
request style sheet information for the application;
evaluate configuration information for a display device or window; and
to render the Web page, set layout of the application based on one or more fields of the style sheet information for the application and based on the configuration information for the display device or window, wherein the one or more fields are one or more media tags.

7. The computer system of claim 1, wherein, to handle the user input, the container is further configured to:
receive a user input event; and
pass the user input event to one of the services or a component of the application, or process the user input event.

8. The computer system of claim 1, wherein the backend server is further configured to:
receive an indication of language or locale;
based on the indication of language or locale, retrieve strings of text elements of the user interface of the application; and
return the strings to the container, wherein the rendered Web page uses the strings.

9. The computer system of claim 1, wherein the container is further configured to:
detect an error condition for the application, wherein the error condition is a network error condition, service error condition, or application error condition; and
to request the Web page, request a standby version of the Web page from the backend server.

10. The computer system of claim 1, wherein the container is further configured to:
detect an error condition for a given service of the services; and
request an offline version of the given service from the backend server, wherein the offline version of the given service is a static Web page.

11. The computer system of claim 1, wherein the container is further configured to:
declare a script function in a document object model;
initialize an operation of the application; and
in response to invocation of the operation of the application within the container, call the script function to perform the operation.

12. The computer system of claim 11, wherein invocation of the operation by a Web browser fails to call the script function to perform the operation.

13. The computer system of claim 1, wherein the container is further configured to:
generate an authentication token when initializing the application; and
pass the authentication token to a client, wherein the client is one of the services or a desktop client.

14. The computer system of claim 13, wherein the container is further configured to:
receive a request to invoke a script function defined in a document object model; and
check that the request is accompanied by the authentication token as a condition of invoking the script function.

15. The computer system of claim 1, wherein the application architecture further includes:
a cache configured to store Web pages and related resources for the application;
and wherein the container is further configured to:
check whether the cache includes a given Web page or related resource; and
check whether the given Web page or related resource has changed since being stored in the cache.

16. The computer system of claim 1, wherein the container is further configured to:
check whether an external Web link corresponds to a script function defined in a document object model;
if so, invoke the script function to launch a service to de-reference the external Web link; and
otherwise, launch a new browser window to de-reference the external Web link.

17. In a computer system, a method comprising, with a container in an application architecture:
requesting a Web page for an application;
requesting at least some resources for the application from a backend server embedded in the application;
receiving the requested Web page;
receiving the requested at least some resources from the backend server;
rendering the Web page, wherein the rendered Web page includes elements of a user interface of the application, at least some of the elements of the user interface being actuatable to launch services;
handling user input to the application; and
launching one of the services.

18. The method of claim 17, further comprising, with the container:
parsing markup language code for the Web page, wherein, the markup language code includes one or more of hypertext markup language code and extensible markup language code;
creating a document object model; and
interpreting script code for the Web page.

19. A non-transitory computer-readable medium storing computer-executable instructions for causing a computer system, when programmed thereby, to perform, with a container in an application architecture:
requesting a Web page for an application;
requesting at least some resources for the application from a backend server embedded in the application;
receiving the requested Web page;
receiving the requested at least some resources from the backend server;
rendering the Web page, wherein the rendered Web page includes elements of a user interface of the application, at least some of the elements of the user interface being actuatable to launch services;
handling user input to the application; and
launching one of the services.

20. The computer-readable medium of claim 19, wherein the services include one or more of a service to acquire data, a Web browser, a chat service, and a help service.
